(19) United States
(12) Patent Application Publication
(10) Pub. No.: US 2024/0119305 A1
(43) Pub. Date: Apr. 11, 2024

(54) ENERGY-EFFICIENT DEEP NEURAL NETWORK TRAINING ON DISTRIBUTED SPLIT ATTRIBUTES

(71) Applicant: Telefonaktiebolaget LM Ericsson (publ), Stockholm (SE)

(72) Inventors: Selim ICKIN, Stocksund (SE); Konstantinos VANDIKAS, Solna (SE)

(21) Appl. No.: 18/276,972

(22) PCT Filed: Feb. 11, 2022
(86) PCT No.: PCT/SE2022/050144

§ 371 Date: Aug. 11, 2023

Related U.S. Application Data
(60) Provisional application No. 63/149,474, filed on Feb. 15, 2021.

(51) Int. Cl. G06N 3/098

(52) U.S. Cl. CPC G06N 3/098

(57) ABSTRACT

A method of operating a master node in a vertical federated learning, vFL, system including a plurality of workers for training a split neural network includes receiving layer outputs for a sample period from one or more of the workers for a cut-layer at which the neural network is split between the workers and the master node, and determining whether layer outputs for the cut-layer were not received from one of the workers. In response to determining that layer outputs for the cut-layer were not received from one of the workers, the method includes generating imputed values of the layer outputs that were not received, calculating gradients for neurons in the cut-layer based on the received layer outputs and the imputed layer outputs, splitting the gradients into groups associated with respective ones of the workers, and transmitting the groups of gradients to respective ones of the workers.

### BACKGROUND

The present disclosure relates generally to distributed machine learning systems for training deep neural networks, and in particular to distributed machine learning systems, such as federated learning systems, which are a subset of distributed machine learning systems, for training deep neural networks for modeling and controlling wireless communication networks.

As more and more 5G telecommunications equipment is being deployed, there is a corresponding increase in the expectation of the marketplace for improved QoE (Quality of Experience) and greater energy-efficiency. As the complexity of telecommunications networks is also increasing, there is an increasing demand for automated and smart decision-making components to be used.

The increased complexity of telecommunications networks and the need for denser deployments suggests a greater need for telecommunications networks to employ an edge computing paradigm in which processing power is more decentralized. This has the potential to reduce latency and also to protect data privacy, which may be required when parts of a network are owned and/or operated by different entities.

Different elements of a network, which may be controlled by different entities, may possess information that is important for training machine learning systems for controlling the overall network, as they may host different sensors and network performance measurement probes that accumulate observations of different aspects of the network, referred to herein as “orthogonal measurements.”

The EUTRAN/Evolved Packet Core (EPC) and NR/5G Core (5GC) networks are composed of segmented network components that are inherently distributed, as shown in FIG. 1. In particular, FIG. 1 illustrates different network components that are involved with setting up and maintaining an end-to-end connection (E2E) between a UE and a peer, along with the underlying bearers that support the communication for both an EUTRAN (upper side of FIG. 1) and NR (lower side of FIG. 1) architecture. Each component supports different parts of the connection. Measurements may be collected by each of the network components. Measurements may be collected synchronously, i.e., either for the same predefined time interval, or for the same object, such as the same session. These measurements may be collected and merged at a centralized node, which may use the observations to train one or more machine learning models for various, such as predicting key performance indicators (KPIs), estimating quality of experience (QoE), etc. There are some drawbacks to such a centralized approach.

For example, the granularity of the datasets collected by the nodes may be high. Transmitting datasets from all distributed nodes to a fully centralized node may be expensive in terms of network data transfer cost and data transfer time. Additionally, once all datasets are obtained at the central node, the combined dataset must be processed, an operation that may be expensive due its computational complexity.

In general, the training time of a Machine Learning (ML) model should be fast so as to be able to adapt to the dynamics of network's environment. Moreover, energy consumption should be as low as possible to reduce the carbon-footprint of the system and also to reduce the energy expense for the network's operator. These goals may be difficult to meet with a centralized system.

There are known ML techniques, such as Split Neural Networks, that enable training on orthogonal datasets (also known as split features). A Split Neural Network has the advantage that it can train a ML algorithm without the need to have raw datasets sent to a fully centralized computation node. This may reduce the bandwidth/throughput requirements of training a neural network (NN) using data collected from many different sources in exchange for added complexity of the ML system.

A distributed NN model is illustrated in FIG. 2. As seen therein, a single NN may be split between worker nodes 120A, 120B and a master node 110, with the worker nodes hosting one set of layers 210, 212 of the NN and the master node hosting another set of layers 214, 216 of the NN. Each layer includes a set of neurons that receive, process and output data to the next layer.

The input layer 210 of the NN, which is hosted by the workers 120A, 120B, receives a number of features f₁ to f_{N} that correspond to measurements made by the workers 120A, 120B. As shown in FIG. 2, different workers may collect data related to different features of the network. That is, the workers may not all collect data for the same features. For example, a worker that is a UE may collect data relating to received signal strength (RSSI) of a downlink signal, while a worker that is a gNB may collect data relating to uplink signal quality.

As shown in FIG. 2, worker 120A collects data relating to features f₁ to f₄, while worker 120B collects data relating to features fₙ₊₁-fₙ₊₄. In addition to the input layer 210, each worker node may host zero or more other layers of the NN model, including intermediate layers 224 and an output layer, or cut-layer, that faces the master node 110. The master node 110 hosts the remaining layers 214, 216 of the NN, including a cut-layer 214 that faces the workers 120A, 120B.

It will be appreciated that although various nodes may be referred to as a “worker” or “master” for explanatory purposes, in some implementations there may be no fixed master or worker. That is, each node participating in vertical federated learning system may be a peer node. In this disclosure, a “master” node is a node tasked with combining the input of more than one workers. In a horizontal FL system, this is usually known as the parameter server. Even though there is such a node in the system (whether termed the master node or the parameter server) it's cut-layer, and by extension it's input feature space is the aggregate of all other input layers originating from the remaining workers. As such, this node can become a logical function and instead of having it in a fixed spot in the federated learning system, the role of master node could migrate to different parts of the network and perform aggregation with as many workers as are available in the system. This could also be useful in the case where the workers cannot communicate with the master, in which case they may nominate a new master node. When communication with the previous master is resolved, the new master node could participate as a representative of the worker nodes.

When the NN is being trained, the workers 120A, 120B process input data corresponding to the features using the one or more NN layers and transmit the resulting values output by their last layer up to the master node 110. The master node 110 computes gradients of the NN neurons and transmits the gradients back down to the workers 120A, 120B. As noted above, the layers 212, 214 at which the NN is separated between the workers and the master node are referred to as the “intermediate layers” or “cut-layers.”

A distributed NN can be jointly trained by combining the outputs of intermediate layers at the master node 110. Each worker 120A, 120B performs a forward-pass on multiple neural network layers at every worker node until its final layer. A forward-pass may include a cascaded form of linear transformations which are done via matrix multiplication of outputs of the neurons of the previous layers with the neuron weights, followed by a non-linear transformation (e.g., ReLu).

Since the training labels are not known the workers 120A, 120B, an error computation is done at the master node 110. Therefore, the outputs of the last layer of the neural network models at every worker 120A, 120B are sent over a communication channel to the master node 110 where they are further concatenated and connected to the first layer of the master node 110.

The forward-pass (cascaded linear and non-linear transformations) continues until the last layer 216 of the master node 110. The last layer 216 of the master node 110 contains the neuron(s) that output the final predicted/estimated value. The output is compared with a ground truth label, and an error computation is performed. Based on the error computation on every sample for which the forward pass was performed, the gradients at every neuron are computed, and the weights (i.e., the coefficient matrix of the neurons) are then adjusted to minimize/reduce the prediction/estimation error.

The master node 110 updates the weights until the first layer 214 (which is the interface cut-layer), and then the gradients are passed back to each worker 120A, 120B after splitting the gradients to each worker 120A, 120B. Note that in the example shown in FIG. 2, the two workers 120A, 120B receive only the gradients associated with their neurons. After the worker nodes 120A, 120B receive their gradients, they continue with back-propagation on the local neurons layer-by-layer in the reverse direction until the first layer. Once the neuron weights are updated, the first round of training is complete. After sufficient iterations back and forth between the workers 120A, 120B and the master node 110, the NN model reaches convergence and is ready to be used as an inference engine.

FIG. 3 illustrates signal flow in a conventional vertical federated learning (vFL) system between a master node 110 and workers 120A, 120B. As shown in FIG. 3, the master node 110 relies for its operation on receiving layer values from the workers 120A, 120B, while the workers 120A, 120B rely for their operation on receiving gradient values from the master node 110. In particular, after initialization, the workers 120A, 120B perform a forward pass on input features and generate layer outputs, which are transmitted to the master node 110. The master node 110 concatenates the values received from the workers 120A, 120B, performs a forward pass to obtain the final output and computes the resulting error, and then performs back-propagation of the resulting error to compute new gradients. The master node 110 splits the gradients and transmits the split gradients to the respective workers 120A, 120B, which then perform back-propagation using the received gradients to correct the neuron weights. The process is then repeated on a new batch of training data.

### SUMMARY

A method of operating a master node in a vertical federated learning, vFL, system for training a split neural network, the vFL system including a plurality of workers includes receiving layer outputs for a sample period from one or more of the workers for a cut-layer at which the neural network is split between the workers and the master node, and determining whether layer outputs for the cut-layer were not received from one of the workers. In response to determining that layer outputs for the cut-layer were not received from one of the workers, the method includes generating imputed values of the layer outputs that were not received, calculating gradients for neurons in the cut-layer based on the received layer outputs and the imputed layer outputs, splitting the gradients into groups associated with respective ones of the workers, and transmitting the groups of gradients to respective ones of the workers.

The method may further include determining whether layer outputs for the cut-layer were not received from the one of the workers from which layer outputs were not received for more than a threshold number of sample intervals, and in response to determining that layer outputs for the cut-layer were not received from the one of the workers from which layer outputs were not received for more than the threshold number of sample intervals, re-shaping the cut-layer of the split neural network to exclude neurons associated with the one of the workers from which layer outputs were not received.

In some embodiments, the method may further include determining a new training batch size, cut layer, and/or neuron count for the split neural network based on the re-shaped cut-layer.

In some embodiments, the method may further include determining whether an accuracy of the split neural network is increasing or decreasing after a training round, and in response to determining that the accuracy of the neural network is increasing, reducing a network footprint of the split neural network.

Reducing the network footprint of the neural network may include performing at least one of: reducing a training batch size the neural network, reducing a number of neurons in a cut-layer of the split neural network, and increasing a drop-out rate for neurons in the cut-layer of the split neural network.

In some embodiments, the method may further include informing the workers of the change to the network footprint.

In some embodiments, the method may further include, in response to determining that the accuracy of the neural network is decreasing, performing at least one of: increasing a training batch size the neural network, increasing a number of neurons in a cut-layer of the split neural network, and reducing a drop-out rate for neurons in the cut-layer of the split neural network.

Determining whether the accuracy of the split neural network is increasing or decreasing may include generating a moving average of an accuracy score associated with the split neural network. The accuracy score may include an F1-score.

Imputing the imputing values of the layer outputs that were not received may include generating synthetic values of the layer outputs that were not received using a generative model based on previously received values of the layer outputs that were not received.

The generative model may take into account previously received values of layer outputs other than the layer outputs that were not received in addition to the layer outputs that were not received.

The generative model may include a multivariate timeseries model.

In some embodiments, the method may further include smoothing the imputed values of the layer outputs that were not received using an exponential smoothing algorithm based on a previously used layer output value.

The smoothing may be performed according to the operation:

At′←At+(1−w)At−1
where At′ is the layer output to be used at sample interval t, At is the imputed layer output at sample interval t, At−1 is the layer output previously used at sample interval t−1, and w is a smoothing weight.

In some embodiments, the method may further include determining that new layer outputs are being received from the one of the workers from which layer outputs were previously not received, and smoothing the new layer outputs based on a previously used imputed layer output.

The smoothing may be performed according to the operation:

At′←wAt−1+(1−w)Rt
where At′ is the layer output to be used at sample interval t, Rt is the actual layer output at sample interval t, At−1 is the layer output previously used at sample interval t−1, and w is a smoothing weight.

The worker nodes may be nodes in a wireless communication network.

In some embodiments, the method may further include identifying a trusted neighbor node of the one of the workers, and obtaining a version of the layer outputs that were not received from the one of the workers from the trusted neighbor node.

In some embodiments, the method may further include combining the version of the layer outputs that were obtained from the trusted neighbor node with a previously imputed set of layer outputs for the one of the workers.

In some embodiments, the method may further include receiving a request from a network node to provide missing gradients for a worker that is a trusted neighbor of the network node, and transmitting the missing gradients to the network node.

The method may further include encrypting the missing gradients prior to transmitting the missing gradients to the network node.

A master node of a vertical federated learning, vFL, system includes processing circuitry, and memory coupled with the processing circuitry. The memory may include instructions that when executed by the processing circuitry causes the master node to perform operations including receiving layer outputs for a sample period from one or more workers in the vFL for a cut-layer at which a neural network is split between the workers and the master node, determining whether layer outputs for the cut-layer were not received from one of the workers, in response to determining that layer outputs for the cut-layer were not received from one of the workers, generating imputed values of the layer outputs that were not received, calculating gradients for neurons in the cut-layer based on the received layer outputs and the imputed layer outputs, splitting the gradients into groups associated with respective ones of the workers, and transmitting the groups of gradients to respective ones of the workers.

Some embodiments provide a computer program comprising program code to be executed by processing circuitry of a master node of a vertical federated learning system, whereby execution of the program code causes the master node to perform operations including receiving layer outputs for a sample period from one or more workers in the vFL for a cut-layer at which a neural network is split between the workers and the master node, determining whether layer outputs for the cut-layer were not received from one of the workers, in response to determining that layer outputs for the cut-layer were not received from one of the workers, generating imputed values of the layer outputs that were not received, calculating gradients for neurons in the cut-layer based on the received layer outputs and the imputed layer outputs, splitting the gradients into groups associated with respective ones of the workers, and transmitting the groups of gradients to respective ones of the workers.

Some embodiments provide a method of operating a worker in a vFL system including a master node for training a split neural network. The method includes determining that gradients for neurons in a cut-layer of the split neural network were not received from the master node, in response to determining that the gradients were not received from the master node, generating imputed values of the gradients, performing backpropagation training of the split neural network using the imputed gradient values, calculating new layer outputs based on the backpropagation training, and transmitting the new layer outputs to the master node.

Generating the imputed values of the gradients may include generating synthetic values of the gradients using a generative model based on previously received values of the gradients.

The generative model may include a multivariate timeseries model.

In some embodiments, the method may further include smoothing the imputed values of the gradients using an exponential smoothing algorithm based on previously received gradients.

The smoothing may be performed according to the operation:

A_{t′}←wAₜ+(1−w)Aₜ₋₁
where A_{t′} is the gradient to be used at sample interval t, Aₜ is the imputed gradient at sample interval t, Aₜ₋₁ is the gradient previously used at sample interval t−1, and w is a smoothing weight with 0<w<1.

In some embodiments, the method may further include determining that new gradients are being received from the master node, and smoothing the new gradients based on a previously used imputed gradients.

The smoothing may be performed according to the operation:

A_{t′}←wAₜ₋₁+(1−w)Rₜ
where Aₜ is the gradient to be used at sample interval t, Rₜ is the actual gradient at sample interval t, Aₜ₋₁ is the gradient previously used at sample interval t−1, and w is a smoothing weight with 0<w<1.

The worker may include a node in a wireless communication network.

In some embodiments, the method may further include identifying a trusted neighbor node, sending a message to the trusted neighbor node requesting that the trusted neighbor node obtain a version of the gradients that were not received from the master node, and receiving the version of the gradients from the trusted neighbor node.

In some embodiments, the method may further include combining the version of the gradients that were obtained from the trusted neighbor node with a previously imputed set of gradients.

The worker may be a first worker, and the method may further include receiving a request from a second worker to obtain missing gradients for the second worker that is a trusted neighbor of the first worker, obtaining a version of the missing gradients from the master node, and transmitting the version of the missing gradients to the second worker.

Some embodiments provide a worker of a vertical federated learning system including processing circuitry, and memory coupled with the processing circuitry. The memory includes instructions that when executed by the processing circuitry causes the network node to perform operations including determining that gradients for neurons in a cut-layer of a split neural network were not received from a master node, in response to determining that the gradients were not received from the master node, generating imputed values of the gradients, performing backpropagation training of the split neural network using the imputed gradient values, calculating new layer outputs based on the backpropagation training, and transmitting the new layer outputs to the master node.

Some embodiments provide a computer program comprising program code to be executed by processing circuitry of a worker of a vertical federated learning system, whereby execution of the program code causes the worker to perform operations including determining that gradients for neurons in a cut-layer of a split neural network were not received from a master node, in response to determining that the gradients were not received from the master node, generating imputed values of the gradients, performing backpropagation training of the split neural network using the imputed gradient values, calculating new layer outputs based on the backpropagation training, and transmitting the new layer outputs to the master node.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates a high-level architectural view of EUTRAN/Evolved Packet Core (EPC) and NR/5G Core (5GC) network elements;

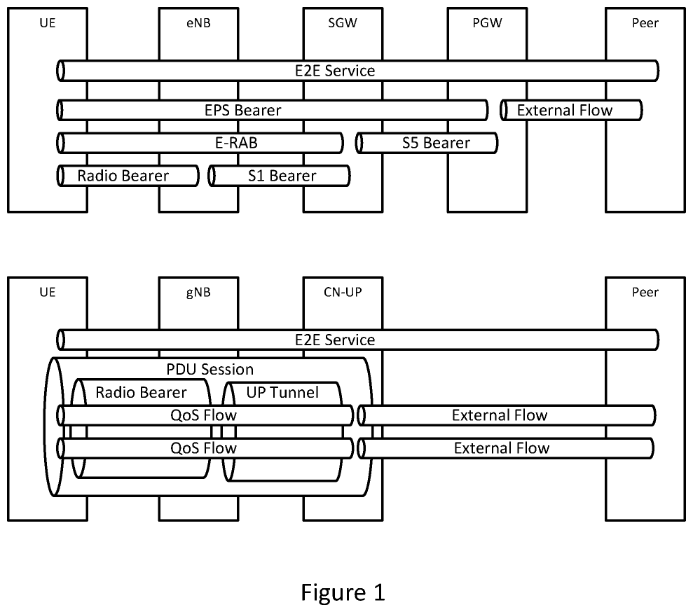

FIG. 2 illustrates a distributed neural network model;

FIG. 3 illustrates signal flow in a conventional vertical federated learning (vFL) system;

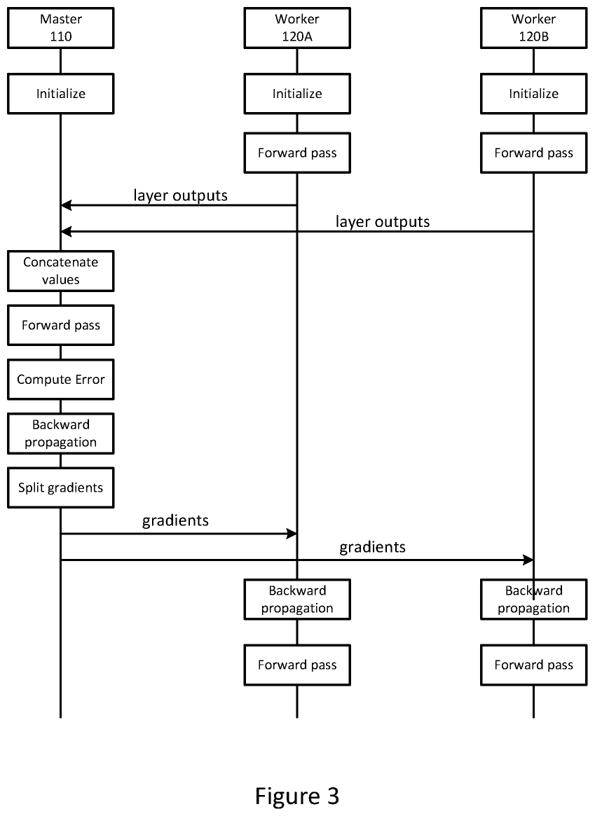

FIG. 4 illustrates elements of a vertical federated learning (vFL) system according to some embodiments;

FIG. 5 is a flowchart that illustrates systems/methods according to some embodiments;

FIG. 6A illustrates operations of imputing missing parameters by a master node according to some embodiments;

FIG. 6B illustrates operations of imputing missing parameters by a worker according to some embodiments;

FIG. 6C illustrates operations of imputing missing parameters by a worker according to further embodiments;

FIG. 6D illustrates operations of imputing missing parameters by a master node according to further embodiments;

FIG. 7 illustrates operations of reshaping a cut-layer by a master node according to some embodiments;

FIG. 8 illustrates a worker pool before and after re-shaping a cut-layer in response to a time-out according to some embodiments;

FIG. 9A is a graph that illustrates an example of the effect of reducing the cut-layer neuron count on the accuracy (F1-score), network footprint and training time according to some embodiments;

FIGS. 9B to 9D are graphs that illustrates an example of reducing batch sizes on network footprint, training time and accuracy (F1-score) over multiple rounds of training according to some embodiments;

FIG. 10 is a block diagram illustrating a wireless device (UE) according to some embodiments of inventive concepts;

FIG. 11 is a block diagram illustrating a network node according to some embodiments of inventive concepts;

FIG. 12 is a block diagram illustrating a master node according to some embodiments of inventive concepts;

FIGS. 13 and 14 are flow charts illustrating operations of network nodes according to some embodiments of inventive concepts;

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

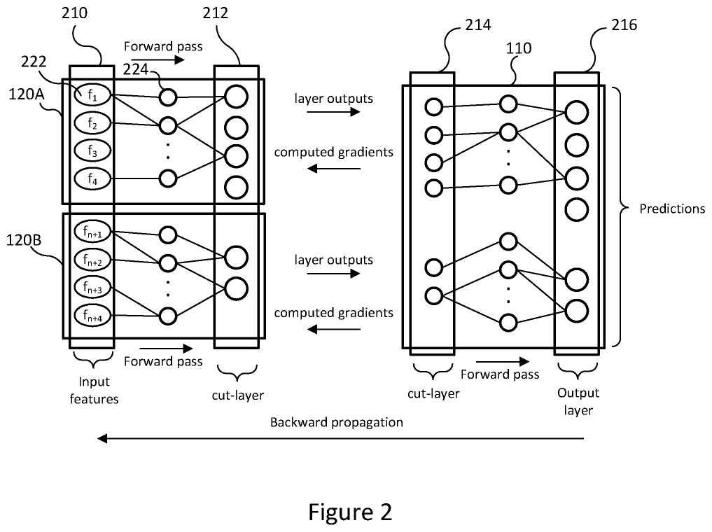

A vertical federated learning (vFL) solution that functions via Split Neural Network such as shown in FIG. 2 is known. The functionality requirements for vFL are more restrictive than horizontal federated learning (hFL). For example, vFL requires that all parties need to participate in every round (as all parties are jointly providing input from orthogonal split attributes) at every round. Accordingly, there is a need for additional fault-tolerant mechanisms in a vFL system to handle the cases when one or more collaborating workers stop providing required inputs to the master model. There are a few open challenges to address in this setting.

First, the loss of a node and/or the failure of a communication link might cause some of the workers and/or the master node not to be able to receive the information needed for training. For example, failure of a communication link between a worker and the master node may prevent the node from receiving outputs from the worker and/or prevent the worker from receiving gradients from the master node.

Providing fault-tolerance if/when a worker stops sending outputs to the master node during training is an important challenge. Due to the dependency of the training process on all workers, the training would stop in that scenario. In a conventional cross-device FL scenario, selection of a subset of workers from a millions of workers every round would not be such a problem and would be better for model operation cost perspectives. However, in a cross-silo setting where there are fewer collaborators, the failure to receive required outputs from nodes is an issue. Therefore, solutions to handle such situations that enable smooth training without disrupting the process are needed.

Second, the high network footprint and training time can be a problem for vFL solutions. A standard vFL approach may have a high cost of data transfer since it can be very difficult to define the expected neural architecture for the workers/master in conjunction with the shape of the cut-layer.

Some embodiments described herein provide systems/methods that address the loss of one or more workers due to a failure in a communication link or other failure (e.g., software fault, hardware failure, etc.) that prevents them from transmitting/receiving data. For example, some embodiments provide systems/methods that impute missing data from historical training traces using generative models. In other words, nodes (e.g. a worker or master node) that miss an input (either gradients or outputs depending on the direction of transfer) will generate synthetic gradients or outputs for use in a subsequent training round.

If a worker does not participate for some number of rounds (e.g., at a round less than a threshold timeout round count), the real received input (either gradients or the output values depending on the direction of the transfer) at the current round may be smoothed out, for example via weighted averaging of synthetic values and real input values.

If a worker does not participate for more than some threshold number of rounds, the cut-layer neurons of the NN may be reshaped so that the NN does not rely any more on the missing inputs. This solution can be applied in the case when one or more workers are unable to communicate for a long period.

Some embodiments may reduce the network footprint and training time of a vFL network by one or more actions, such as reducing the number of neurons at the interface layers while sustaining the accuracy of the model (e.g., as measured by the F1-score, area under the curve (AUC), r2-score, mean absolute error, mean square error, or other accuracy metric), reducing the training samples passed over during training at every round, i.e., adjust the optimum batch size, and/or adding a “dropout” functionality on the cut-layers such that only the values associated with a selected subset of the cut-layer neurons are sent over the communication link. Dropout functionality is a known technique that is used to prevent over-fitting of a NN. In a vFL context, the application of dropout functionality at the cut-layer may reduce communication costs.

Some advantages of the systems/methods described herein may include facilitating smooth/uninterrupted training despite a communication or processing failure. Some embodiments described herein may provide reduced training time yields a faster training hence faster deployment. Moreover, reducing the batch size may help to reduce training time and also the network footprint. A reduced neuron count at the cut-layer may reduce the training time and/or network footprint of a vFL system. Due to the reduced training time and network footprint, energy consumption is expected to be reduced significantly.

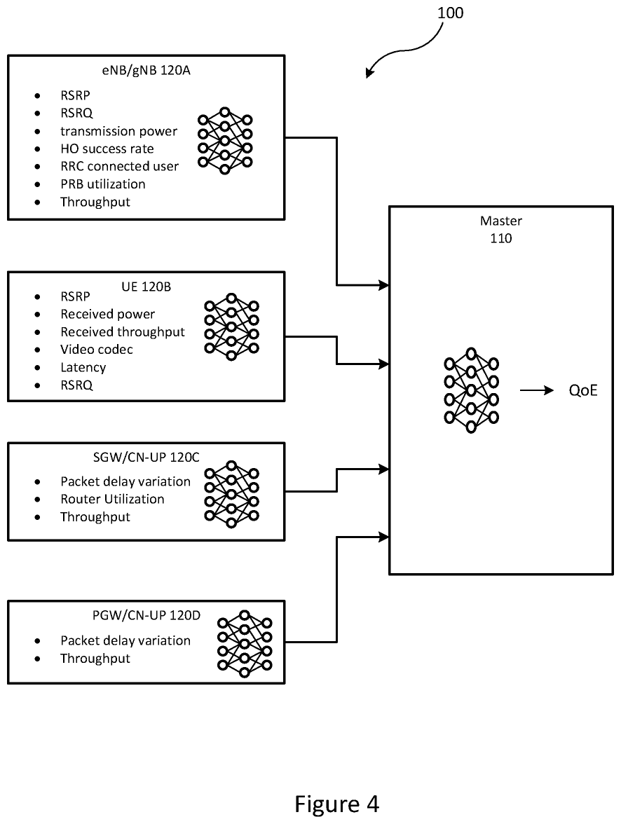

A potential application for vFL systems/methods described herein is for training a NN to estimate QoE based on distributed observations from different parts of a telecommunications network, where different nodes in a network may observe different aspects of a connection. For example, referring to FIG. 4, a vFL system 100 is illustrated that includes a master node 110 and a plurality of worker nodes 120A-120D, namely, a base station (eNB/gNB) 120A, a UE 120B, a serving gateway (SGW) 120C and a packet gateway (PGW) 120D which act as worker nodes. The base station 120A may observe features such as RSRP, RSRQ, transmission power, handover success rate, throughput, etc., while the UE 120B may observe features such as latency, received signal power, etc. Other nodes, such as the SGW 120C, may observe features such as packet delay and router utilization. Each of these network elements may be provisioned by different business segments of an overall network, such as different operators and/or service providers. For the parties to jointly train a model on the same context, the parties can either use a common identifier, such as a PDP session ID, or another session ID that can be shared and accessed across the nodes. Alternatively, a negotiated time window can be used to organize samples.

Another potential application in the context of telecommunications networks relates to 5G slicing, such as by training a NN model on different slices. That is, a model may be trained that dynamically estimates an optimal resource distribution combination on different slices depending on orthogonal observations obtained on each slice.

As opposed to hFL, which assumes the same feature space but different samples obtained by different workers, vFL assumes a different feature space but with coordinated samples obtained by the workers. Therefore, in order to apply vFL in a telecommunication network, different unique identifiers need to be used to make sure that measurements that are made at different nodes refer to the same sample. In the context of network slicing according to the 5G IETF Network Slice NBI Information Model (https://tools.ietf.org/id/draft-rokui-5g-ietf-network-slice-00.html) a few exemplary identifiers are the following:
s-nssai: 5G e2e network slice id
5 g-customer: 5 g tenant
5g-mobile-service-type: i.e. cctv
Connection-group-id: identifier of for the connection i.e. p2p

In an IMS context another example can be the Session ID used in the SIP invite which can be used to track the quality of the SDP protocol during a Voice over IP discussion.

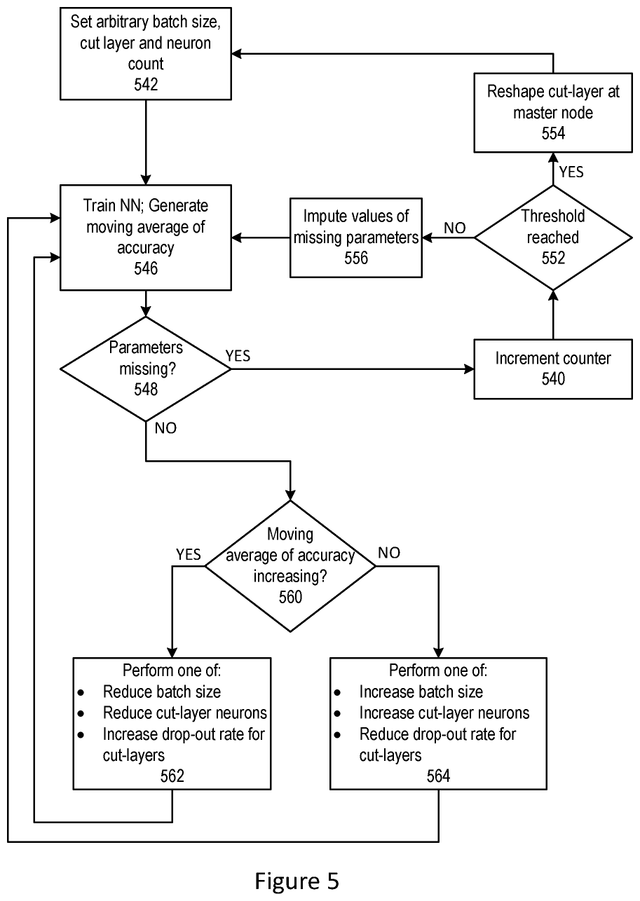

FIG. 5 illustrates operations of a master node 110 and workers 120A-D according to some embodiments. Referring to FIGS. 4 and 5, at block 542, the process begins when the master node 110 sets an arbitrary batch size, cut layer and neuron count for a distributed NN. The master node 110 and the workers 120A-D then jointly train the NN as described above at block 546. As part of the training, layer values for each sample are provided by the workers 120A-D to the master node 110, and gradient values are provided by the master node 110 to the workers 120A-D.

At block 548, the master node 110 determines if any of the parameters (layer values) are missing, e.g., if there was a communication failure between at least one of the workers 120A-D and the master node 110. If one or more layer values are missing, the master node 110 increments a counter c at block 550. At block 552, the master node 110 determines if parameters are missing from a threshold number of samples. If not, at block 556, the master node 110 imputes synthetic values of the missing parameters as described in more detail below, and the master node 110 continues to train the NN using the synthetic values at block 546. Otherwise, if the threshold number of samples with missing parameters is reached at block 552, the master node 110 reshapes the cut-layer, such as by discarding features associated with a non-communicative worker, and operations return to block 502 to restart the process.

If at block 548 it is determined that no parameters are missing, operations proceed to block 560, where the master node 110 computes a moving average of an accuracy metric of the NN and determines if the accuracy of the NN is increasing. If so, operations proceed to block 562, where the master node 110 takes an action to reduce the network footprint and/or training time of the vFL system, such as reducing the batch size (i.e., the number of samples processed in each training iteration), reducing the number of neurons in the cut-layer, increasing the dropout rate for the cut-layer, etc. That is, as long as the accuracy of the NN continues to increase with each training round, the master node 110 may take action to reduce the expense of training. Any change in the structure of the NN, such as the number of nodes in a layer, may be communicated back to the workers 120A-D by the master node 110.

If, however, the moving average of the accuracy is determined to be decreasing at block 560, the master node 110 at block 564 performs an action to increase the accuracy of the NN, such as increasing the batch size, increasing the number of cut-layer neurons and/or reducing the dropout rate for the cut-layers.

In either case, after adjusting the training process at block 562 or 564, operations return to block 506 where the training cycle is repeated.

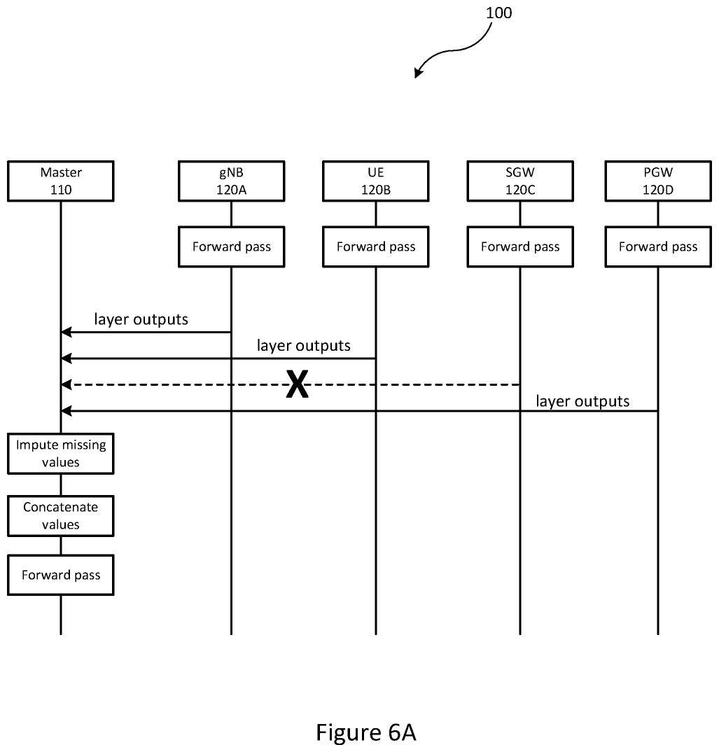

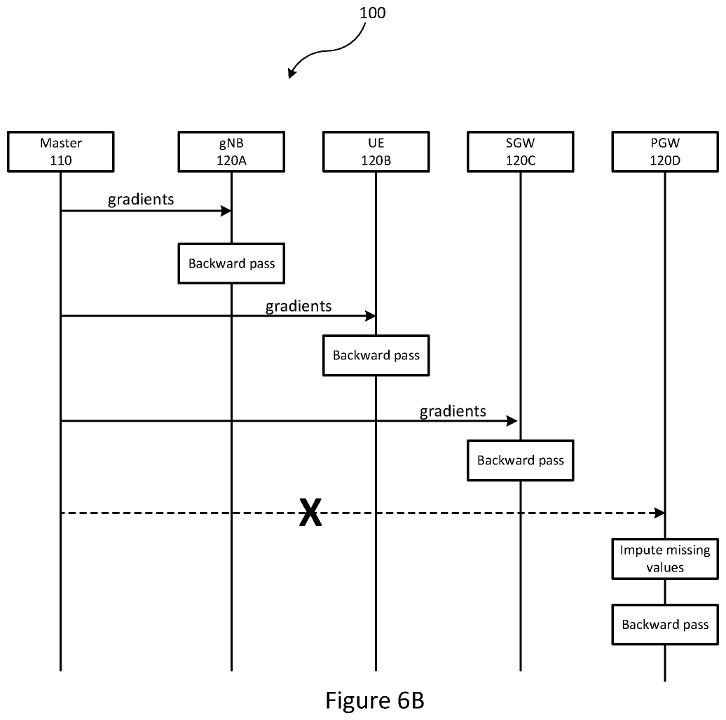

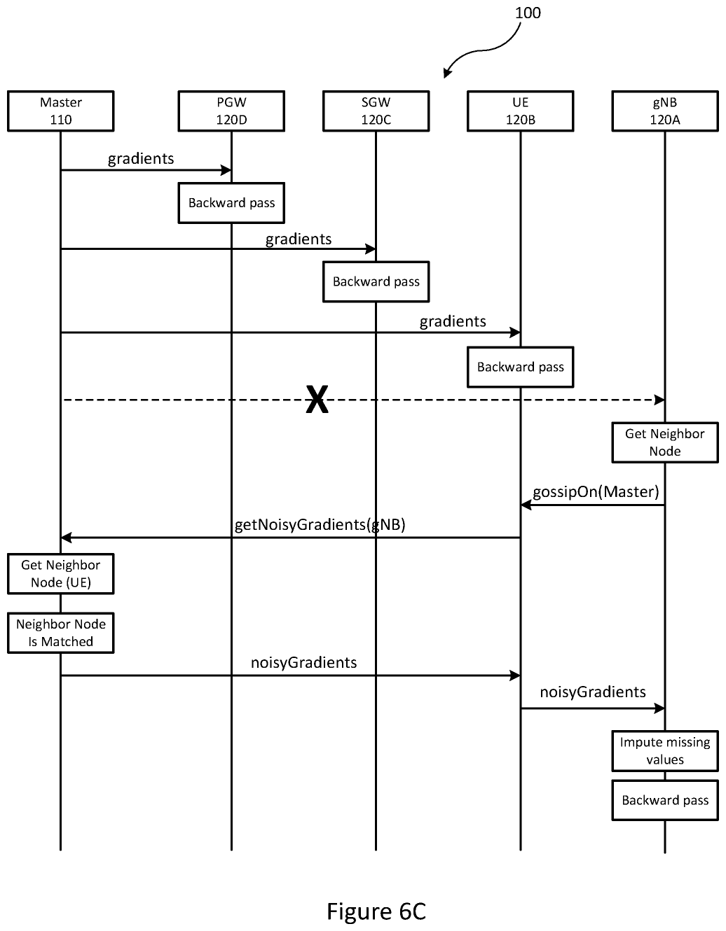

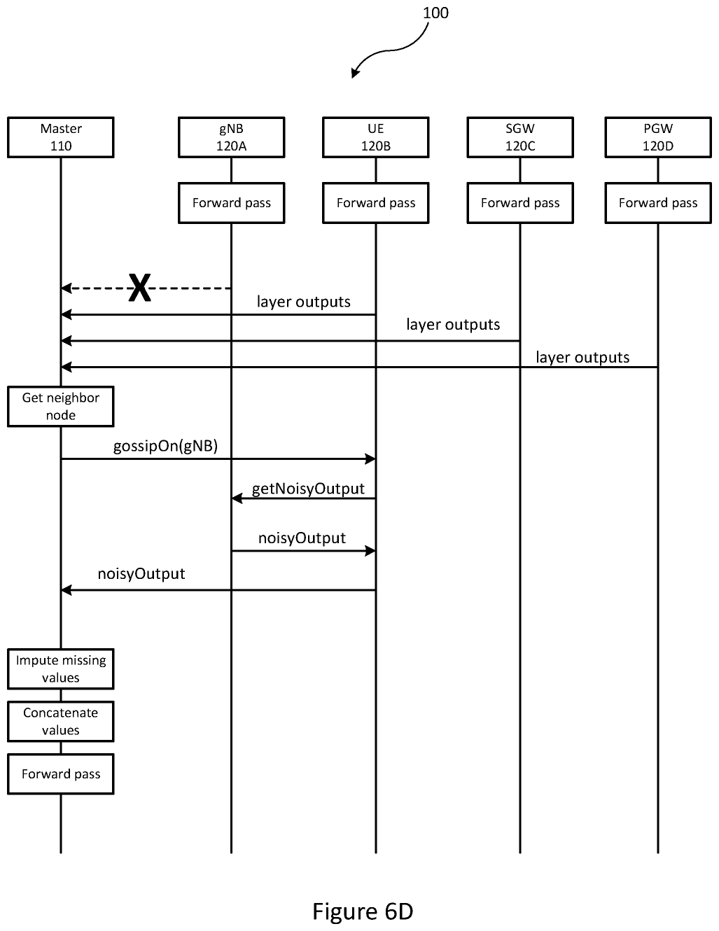

Operations of imputing missing parameters by a master node 110 are illustrated in FIG. 6A, which shows a vFL system 100 including the master node 110 and workers 120A-D. The master node 110 receives layer outputs from the workers 120B-D, but fails to receive the layer outputs from the worker 120C. When the layer outputs from the worker 120C are not received, the master node 110 generates synthetic outputs for the worker 120C by imputing the value of the missing outputs. The synthetic outputs for the worker 120C may be generated, for example, based on past outputs of the worker 120C. In some embodiments, the synthetic outputs for the worker 120C may be generated according to a model that takes into account current and/or past outputs of the other workers 120A, 120B, 120D. For example, one or more of the features observed by the worker 120C may be correlated with one or more features observed by the other workers 120A, 120B, 120D. Accordingly, the master node 110 may take the current and/or past layer outputs of the other workers 120A, 120B, 120D into account when imputing the value of the missing layer outputs from the worker 120C.

The master node 110 then concatenates the real layer outputs from workers 120A, 120B, 120D with the synthetic outputs for worker 120C and continues training the NN.

The model that imputes the missing layer outputs can be, for example, a multivariate timeseries generative model where each of the gradients from all workers are given as input at every timestep (round).

Some embodiments may provide a mechanism to improve the missing values in the generation process (in case a worker does not send layer outputs) so that a generator/impute model at the master aims to increase the quality of the imputed values based on accuracy feedback. This approach may be valid only for temporary drop-outs of some workers. The approach may include internal fine-tuning at the master node the generated values (corresponding to the missing values from a worker) to increase accuracy. This additional feedback loop has no communication overhead, since the master node can re-compute loss iteratively as it has access to all labels.

For the generation process at the worker (in the case it does not receive gradients from master node), a full round-trip is necessary, hence higher overhead would be required.

An example of input attributes that are needed to estimate the missing output from a worker 120A at the master node 110 is given Table 1, which illustrates a multivariate timeseries of the flattened outputs all workers since the start of the training process. The t variable stands for the round id.

TABLE 1
Input and the output values are given
for the generative timeseries model.

| Input Matrix | | | | | Output vector |
|---|---|---|---|---|---|
| (Output values of | | | | | (Estimated Output value of cut- |
| cut-layer neurons) | | | | | layer neurons of missing worker) |
| | t − N | . . . | t − 2 | t − 1 | t |
| worker 1 | | | | | y′ |
| worker 2 | | | | | |
| . . . | . . . | . . . | . . . | . . . | |
| worker M | | | | | |

FIG. 6B illustrates an example scenario in which the master node 110 cannot send the computed gradients back to one of the workers, namely worker 120D (the PGW). In that case, the worker 120D may impute the missing gradients from the historical gradients received from the master node 110, such as using a timeseries prediction/generative model that generates synthetic gradients based on past gradients provided to the worker 120D according to the formula pgw′=impute(pgw|pgw_previous), where pgw′ are the (imputed) synthetic gradients, pgw are the desired gradients, and pgw_previous are the historical gradients for worker 120D.

This implementation requires persistent storage at the workers 120A-D to store historical values of the gradients and persistent storage at the master node 110 to store the layer outputs received from the workers 120A-D at each round. The trajectory datasets are then used for training a model for estimating the missing inputs.

An example of the input attributes that are needed to estimate the missing gradients from a master node 110 at the worker node 120D are shown in Table 2, which illustrates a multivariate timeseries of the flattened outputs of the gradients received at the worker node 120D from the master node 110 throughout the preceding training rounds. The t variable stands for the round id.

TABLE 2
Imputation of Missing Gradients

| Input Matrix | | | | | Output vector |
|---|---|---|---|---|---|
| (Output values of | | | | | (Estimated Output value of cut- |
| cut-layer neurons) | | | | | layer neurons of missing worker) |
| | t − N | . . . | t − 2 | t − 1 | t |

| | |
|---|---|
| Master | y′ |

Some embodiments condition the missing layer outputs and/or gradients using an exponential smoothing process. In particular, exponential smoothing may be performed on inputs between the training round when the communication is lost and the training round at which communication is restored (when the communication is lost for small number of rounds less than threshold, e.g. 10 rounds) using the following parameters:
t: round id;
T₀: round id of first loss;
w: weight of artificial input (ranging from 0 to 1 with stepsize of s). Since it is desired to weight the current average more than previous average, w can be typically set to 0.75 (mostly used constant in EWMA);
s: fixed small step_size is equal to 0, or close to 0.
s\hat{ }: adaptive step_size (alternatively an adaptive step_size can be used, such as s″).
At′ is the input to be used at round, t.
w′: updated w to be used in the next round, t+1.
w=0.75;

The procedure for exponential smoothing is then given by the following pseudocode:
Aₜ₋₁=Rₜ₋₁;
while(t>T₀ & t<(T₀+threshold)):
   Aₜ←impute( );
   Aₜ←wAₜ+(1−w)Aₜ₋₁;
   w′←w−s; // or alternatively, w←w−s^{(1/t)};
   increment t;

After the break, the effect of the real value before the loss is diminished. Hence, the cut-layer neurons may be reconfigured as described below.

Exponential smoothing of inputs may also be performed after communication is resumed to ensure a smooth transition back to real inputs when the communication is lost for small number of rounds less than a threshold, e.g. 10 rounds. Using the parameters described above with w=0.25, the exponential smoothing process after communication is restored may be given by the following pseudocode:
while(t>T_{after first retrieval of input} & t<(T_{after first retrieval of input}+threshold)):
   Rₜ←receive_real( );
   Aₜ←wAₜ₋₁+(1−w)Rₜ;
   w←w−s; // or alternatively, w←w−s^{(1/t)}
   increment t;

In some embodiments, when a node detects that an input is missing, such as when the master node detects that a set of layer outputs is missing or when a worker detects that a set of gradients is missing, the node may obtain the missing input, or a version or estimate of the missing input from a neighboring node. These embodiments use on a relation graph of the workers that is predefined and built on a trust base that indicates whether a given pair of nodes trust one another. A relation graph of every node in the vFL system is stored in the master node, while workers store a relation graph relative to their nearest (one-step close) neighbors in the communication system. These nearest-neighbor workers may be able to communicate even in the event that a connection is lost between a worker and a master. The missing information may be proxied using the one-step neighboring node.

Referring to FIG. 6C, in an example, the gNB 120A detects that a set of gradients was not received for a given training round. Upon detecting that the set of gradients is missing, the gNB 120A obtains the identity of a nearest-neighbor node, in this case the UE 120B (which may, for example, have a Dual Connectivity connection to a different base station). Once the UE 120B has been identified as the nearest-neighbor node, the gNB 120A sends a request (gossipOn) to the UE 120B asking the UE 120B to obtain the missing gradients from the master node 110. The UE 120B sends a request (getNoisyGradients) to the master node 110 asking for the gradients on behalf of the gNB 120A. The request identifies the node requesting the gradients (i.e., the gNB 120A).

Upon receipt of the request, the master node 110 verifies that the two nodes (UE 120B and gNB 120A) are in fact nearest-neighbors (for example by consulting the relation graph at the master node). Upon determining that the two nodes are trusted nearest-neighbors, the master node 110 grants proxy permission to the UE 120B and sends the gradients, or a version of the gradients, to the UE 120B to be forwarded to the gNB 120A. The gradients sent by the master node 110 may be “noisy” because they may be delayed relative to the actual (missing) gradients that would have been sent. When the gradients are sent to the UE 120B, they may be encapsulated in an encrypted or encoded container such that they can only be decrypted or decoded by the intended target, namely the gNB 120A.

The gNB 120A may then use the received gradients to impute the missing gradients. After imputing the missing gradients, the gNB 120A may ensemble (combine) the imputed gradients with previously imputed gradients (if any). The ensembling step may be performed by obtaining a weighted average of the imputed values. The gNB 120A then performs backwards propagation using the imputed and ensembled gradients.

If there is no proxy available (i.e., the node has no trusted nearest neighbor), the node will perform imputation as described above. However, if a proxy is available, then the previous imputation results may be combined with the proxied gradients as described above.

Referring to FIG. 6D, in an example, the master node 110 detects that a set of layer outputs was not received for a given training round from the gNB 120A. Upon detecting that the set of layer outputs form gNB 120A is missing, the master node 110 obtains the identity of a nearest-neighbor node of the gNB 120A by consulting its stored relation graph. In this case, the master node 120 identifies the UE 120B (which may, for example, have a Dual Connectivity connection to a different base station) as the nearest trusted neighbor of the gNB 120A. Once the UE 120B has been identified as the nearest-neighbor node, the master node 110 sends a request (gossipOn) to the UE 120B asking the UE 120B to obtain the missing layer outputs from the gNB 120A. The UE 120B sends a request (getNoisyOutput) to the gNB 120A asking for the layer outputs on behalf of the master node 110.

Upon receipt of the request, the gNB 120A sends the layer outputs, or a version of the layer outputs, to the UE 120B to be forwarded to the master node 110. The layer outputs sent by the gNB 120A may be “noisy” because they may be delayed relative to the actual (missing) layer outputs that would have been sent. When the layer outputs are sent to the UE 120B, they may be encapsulated in an encrypted or encoded container such that they can only be decrypted or decoded by the intended target, namely the master node 110.

The master node 110 may then use the received layer outputs to impute the missing layer outputs. After imputing the missing layer outputs, the master node 110 may ensemble (combine) the imputed layer outputs with previously imputed layer outputs (if any) for the gNB 120A. The ensembling step may be performed by obtaining a weighted average of the imputed values. The master node 110 then concatenates the imputed values with the layer outputs from other workers and performs a forward training pass.

There may be cases in which communication is lost for a longer time interval (e.g., more than a predetermined threshold). In that case, the cut-layer may be re-shaped. Note that cut-layer re-shaping can be performed simultaneously with exponential smoothing of inputs.

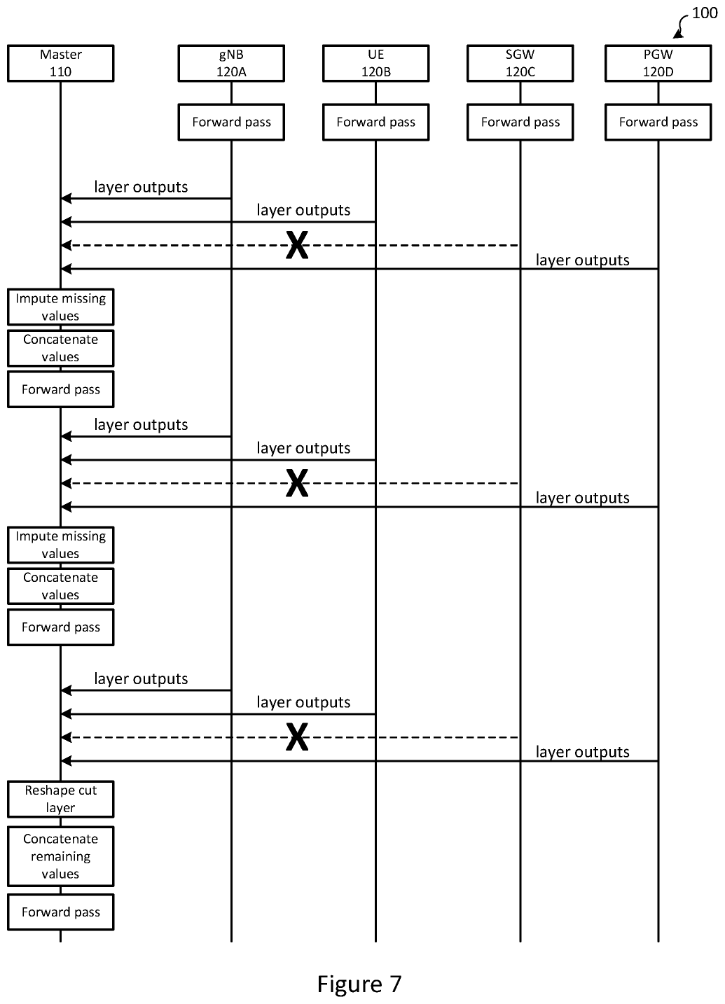

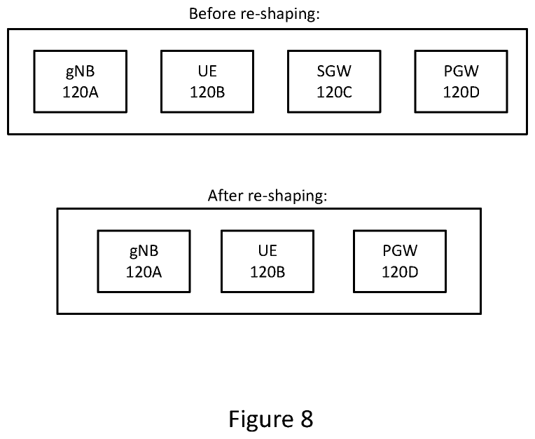

Cut-layer reshaping is illustrated in FIG. 7. In this example, the cut-layer is reshaped after N=3 consecutive failures to receive input from one of the workers (in this case, worker 120C, the SGW). When the cut-layer is re-shaped, the missing worker 120C is removed from the pool of workers contributing to the federation. FIG. 8 illustrates the pool of workers before re-shaping (with the SGW) and after reshaping (without the SGW).

To reduce the overall network footprint, some embodiments may reduce the neuron count at the cut-layer and/or may reduce the batch size based on the accuracy (F1-score), training time, and network footprint observations during training.

In particular, some embodiments may decrease the number of neurons at the cut-layer because the amount of data to be transferred over the communication link is directly related to the number of parameters associated with the cut-layers.

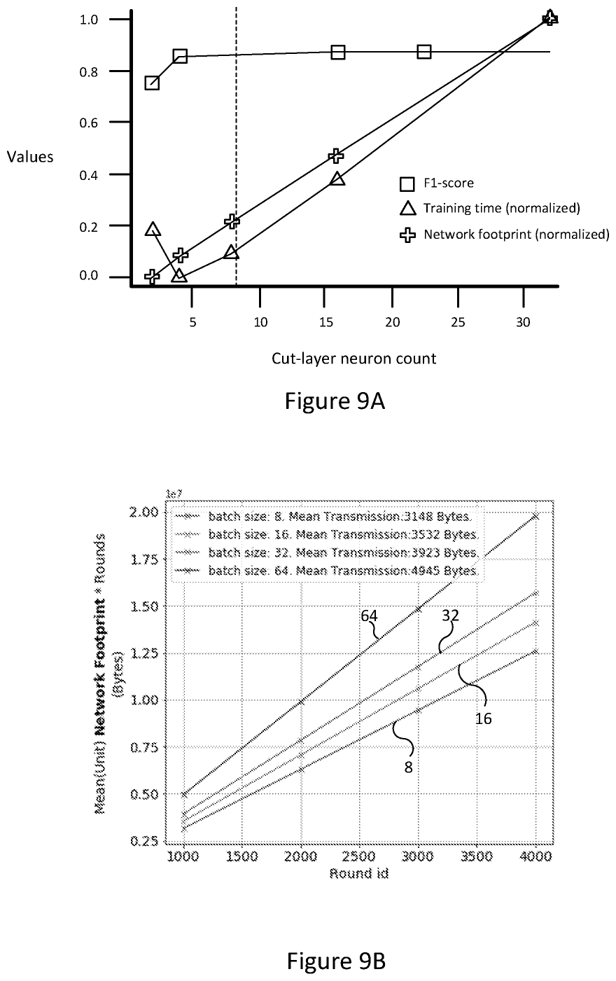

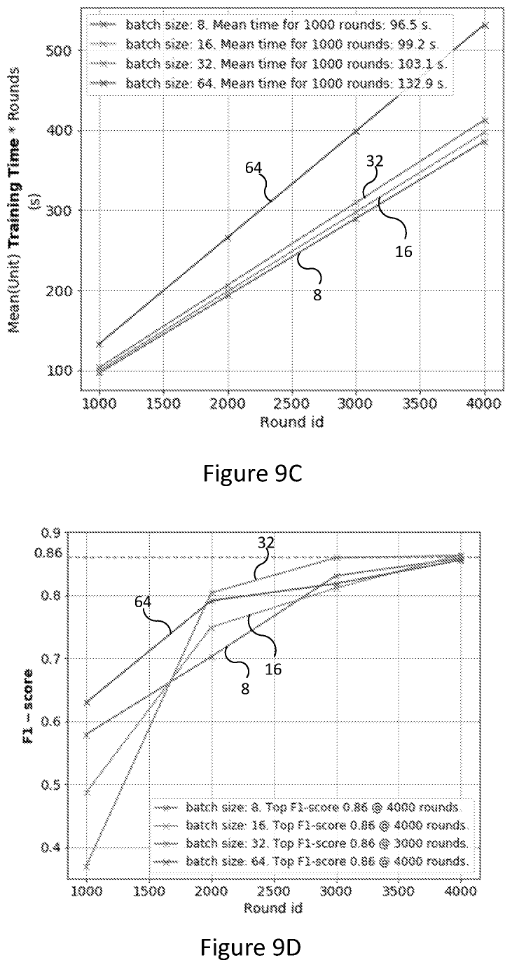

FIG. 9A is a graph that illustrates an example of the effect of reducing the cut-layer neuron count on the accuracy (F1-score), network footprint and training time. As can be seen in FIG. 9A, for the model in question, the accuracy of the model as represented by the F1-score is relatively insensitive to reductions in the cut-layer neuron count until the number of neurons is reduced below a threshold value, which in this example is about 10. Meanwhile, the network footprint and training time are reduced approximately linearly as the cut-layer neuron count decreases. Accordingly, in this example, the system may reduce the number of cut-layers to about 8.

In some embodiments, the size of training batches (batch size) may be reduced such that the gradient updates are not performed with respect to all training samples at every node, but instead are computed only on a subset of training samples. With a smaller number of training samples in each round, fewer output values will be transferred from the workers to the master node, and fewer gradients will be transferred from master to the worker nodes, thereby reducing the throughput requirements of the system.

FIGS. 9B to 9D illustrate the effect of reducing the batch size. In particular, FIG. 9B illustrates the effect of using batch sizes ranging from 8 to 64 on the network foot print expressed in bytes as a function of the number of training rounds. FIG. 9C illustrates the effect of using batch sizes ranging from 8 to 64 on training time expressed in seconds as a function of the number of training rounds, and FIG. 9D illustrates the effect of using batch sizes ranging from 8 to 64 on accuracy (F1-score) as a function of the number of training rounds.

In further embodiments, the drop-out rate at the cut-layer may be tuned. As discussed above, drop-out involves intentionally excluding some neurons in a layer from a given training round. The selection of which neurons to exclude in a given round may be performed randomly or determinatively. The drop-out rate refers to the number of neurons omitted in a given training round. Increasing the drop-out rate at the cut-layer may result fewer values being transferred over the communication link between the master node and the workers. This requires the receiving end to have the information on which of the neurons at the sender are dropped out.

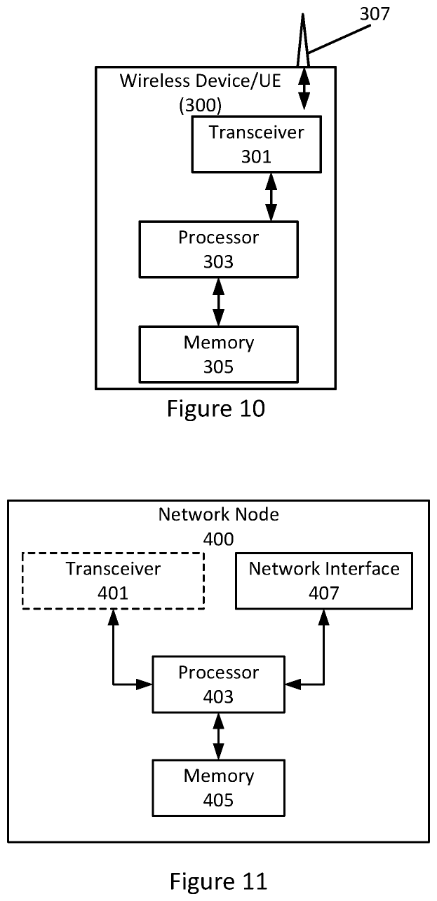

FIG. 10 is a block diagram illustrating elements of a communication device UE 300 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to perform operations of a worker 120 and/or a master node 110 as described herein.

As shown, communication device UE may include an antenna 307, and transceiver circuitry 301 including a transmitter and a receiver configured to provide uplink and downlink radio communications with a base station(s) of a radio access network. Communication device UE may also include processing circuitry 303 coupled to the transceiver circuitry, and memory circuitry 305 coupled to the processing circuitry. The memory circuitry 305 may include computer readable program code that when executed by the processing circuitry 303 causes the processing circuitry to perform operations according to embodiments disclosed herein. According to other embodiments, processing circuitry 303 may be defined to include memory so that separate memory circuitry is not required. Communication device UE may also include an interface (such as a user interface) coupled with processing circuitry 303, and/or communication device UE may be incorporated in a vehicle.

As discussed herein, operations of communication device UE may be performed by processing circuitry 303 and/or transceiver circuitry 301. For example, processing circuitry 303 may control transceiver circuitry 301 to transmit communications through transceiver circuitry 301 over a radio interface to a radio access network node (also referred to as a base station) and/or to receive communications through transceiver circuitry 301 from a RAN node over a radio interface. Moreover, modules may be stored in memory circuitry 305, and these modules may provide instructions so that when instructions of a module are executed by processing circuitry 303, processing circuitry 303 performs respective operations (e.g., operations discussed below with respect to Example Embodiments relating to wireless communication devices). According to some embodiments, a communication device UE 300 and/or an element(s)/function(s) thereof may be embodied as a virtual node/nodes and/or a virtual machine/machines.

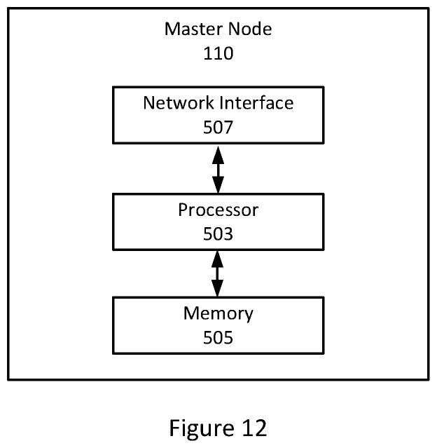

FIG. 11 is a block diagram illustrating elements of a network node 400, which may be used to implement a radio access network (RAN) node or a core network (CN) node of a communication network. The network node 400 may perform operations of a worker 120 and/or a master node 110 as described herein. As shown, when the network node 400 implements a RAN node, the network node may include transceiver circuitry 401 including a transmitter and a receiver configured to provide uplink and downlink radio communications with mobile terminals. The network node may include network interface circuitry 407 configured to provide communications with other nodes (e.g., with other base stations/CN nodes) of the RAN and/or core network CN. The network node may also include processing circuitry 403 coupled to the transceiver circuitry, and memory circuitry 405 coupled to the processing circuitry. The memory circuitry 405 may include computer readable program code that when executed by the processing circuitry 403 causes the processing circuitry to perform operations according to embodiments disclosed herein. According to other embodiments, processing circuitry 403 may be defined to include memory so that a separate memory circuitry is not required.

As discussed herein, operations of the network node may be performed by processing circuitry 403, network interface 407, and/or transceiver 401. For example, processing circuitry 403 may control transceiver 401 to transmit downlink communications through transceiver 401 over a radio interface to one or more mobile terminals UEs and/or to receive uplink communications through transceiver 401 from one or more mobile terminals UEs over a radio interface. Similarly, processing circuitry 403 may control network interface 407 to transmit communications through network interface 407 to one or more other network nodes and/or to receive communications through network interface from one or more other network nodes. Moreover, modules may be stored in memory 405, and these modules may provide instructions so that when instructions of a module are executed by processing circuitry 403, processing circuitry 403 performs respective operations (e.g., operations discussed below with respect to Example Embodiments relating to network nodes). According to some embodiments, network node 400 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

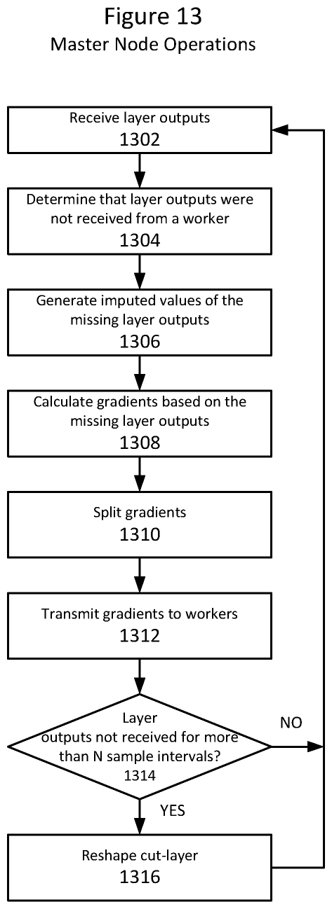

FIG. 12 is a block diagram illustrating elements of a master node 110 of a communication network according to embodiments of inventive concepts. As shown, the master node 110 may include network interface circuitry 507 (also referred to as a network interface) configured to provide communications with other nodes of the core network and/or the radio access network RAN. The master node 110 may also include a processing circuitry 503 (also referred to as a processor) coupled to the network interface circuitry, and memory circuitry 505 (also referred to as memory) coupled to the processing circuitry. The memory circuitry 505 may include computer readable program code that when executed by the processing circuitry 503 causes the processing circuitry to perform operations according to embodiments disclosed herein. According to other embodiments, processing circuitry 503 may be defined to include memory so that a separate memory circuitry is not required.

As discussed herein, operations of the master node 110 may be performed by processing circuitry 503 and/or network interface circuitry 507. For example, processing circuitry 503 may control network interface circuitry 507 to transmit communications through network interface circuitry 507 to one or more other network nodes and/or to receive communications through network interface circuitry from one or more other network nodes. Moreover, modules may be stored in memory 505, and these modules may provide instructions so that when instructions of a module are executed by processing circuitry 503, processing circuitry 503 performs respective operations (e.g., operations discussed below with respect to Example Embodiments relating to core network nodes). According to some embodiments, master node 110 and/or an element(s)/function(s) thereof may be embodied as a virtual node/nodes and/or a virtual machine/machines.

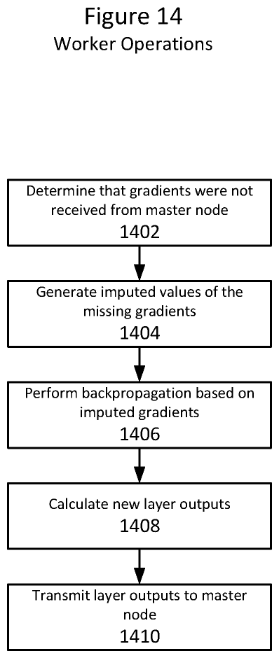

Operations of a master node 110 (implemented using the structure of FIG. 12) will now be discussed with reference to the flow chart of FIG. 13 according to some embodiments of inventive concepts. For example, modules may be stored in memory 505 of FIG. 12, and these modules may provide instructions so that when the instructions of a module are executed by respective processing circuitry 503, processing circuitry 503 performs respective operations of the flow chart.

Referring to FIG. 13, a method of operating a master node (500) in a vertical federated learning, vFL, system for training a split neural network, the vFL system including a plurality of workers, includes receiving (1302) layer outputs for a sample period from one or more of the workers for a cut-layer at which the neural network is split between the workers and the master node, and determining (1304) whether layer outputs for the cut-layer were not received from one of the workers. In response to determining that layer outputs for the cut-layer were not received from one of the workers, the method generates (1306) imputed values of the layer outputs that were not received. The master node then calculates (1308) gradients for neurons in the cut-layer based on the received layer outputs and the imputed layer outputs, splits the (1310) gradients into groups associated with respective ones of the workers; and transmits (1312) the groups of gradients to respective ones of the workers.

In some embodiments, the method further includes determining (1314) whether layer outputs for the cut-layer were not received from the one of the workers from which layer outputs were not received for more than a threshold number of sample intervals; and in response to determining that layer outputs for the cut-layer were not received from the one of the workers from which layer outputs were not received for more than the threshold number of sample intervals, re-shaping (1316) the cut-layer of the split neural network to exclude neurons associated with the one of the workers from which layer outputs were not received.

In some embodiments, the method further includes determining a new training batch size, cut layer, and/or neuron count for the split neural network based on the re-shaped cut-layer.

The may further include determining (560) whether an accuracy of the split neural network is increasing or decreasing after a training round; and in response to determining that the accuracy of the neural network is increasing, reducing (562) a network footprint of the split neural network.

Reducing the network footprint of the neural network may include performing at least one of: reducing a training batch size the neural network, reducing a number of neurons in a cut-layer of the split neural network, and increasing a drop-out rate for neurons in the cut-layer of the split neural network.

The method may further include, in response to determining that the accuracy of the neural network is decreasing, performing (564) at least one of: increasing a training batch size the neural network, increasing a number of neurons in a cut-layer of the split neural network, and reducing a drop-out rate for neurons in the cut-layer of the split neural network.

Determining whether the accuracy of the split neural network is increasing or decreasing may include generating a moving average of an accuracy score associated with the split neural network. The accuracy score may be an F1-score.

Imputing the imputing values of the layer outputs that were not received may include generating synthetic values of the layer outputs that were not received using a generative model based on previously received values of the layer outputs that were not received. The generative model may take into account previously received values of layer outputs other than the layer outputs that were not received in addition to the layer outputs that were not received. In some embodiments, the generative model includes a multivariate timeseries model.

The method may include smoothing the imputed values of the layer outputs that were not received using an exponential smoothing algorithm based on a previously used layer output value. In some embodiments, the smoothing is performed according to the operation:

At′←At+(1−w)At−1
where At′ is the layer output to be used at sample interval t, At is the imputed layer output at sample interval t, At−1 is the layer output previously used at sample interval t−1, and w is a smoothing weight.

The method may include determining that new layer outputs are being received from the one of the workers from which layer outputs were previously not received; and smoothing the new layer outputs based on a previously used imputed layer output.

The smoothing is performed according to the operation:

At′←wAt−1+(1−w)Rt
where At′ is the layer output to be used at sample interval t, Rt is the actual layer output at sample interval t, At−1 is the layer output previously used at sample interval t−1, and w is a smoothing weight.

The worker nodes may be nodes in a wireless communication network.

Referring to FIGS. 12 and 13, a master node (500) of a vertical federated learning system (100) includes processing circuitry (503); and memory (505) coupled with the processing circuitry, wherein the memory includes instructions that when executed by the processing circuitry causes the network node to perform the operations described above with respect to FIGS. 5 and 13.

Referring to FIGS. 12 and 13, a master node (500) of a vertical federated learning system (100) adapted to perform the operations described above with respect to FIGS. 5 and 13.

Referring to FIGS. 12 and 13, a computer program comprising program code to be executed by processing circuitry (503) of a master node (500) of a vertical federated learning system (100), whereby execution of the program code causes the master node (500) to perform the operations described above with respect to FIGS. 5 and 13.

Referring to FIGS. 12 and 13, a computer program product comprising a non-transitory storage medium including program code to be executed by processing circuitry (503) of a master node (500) of a vertical federated learning system (100), whereby execution of the program code causes the master node (500) to perform the operations described above with respect to FIGS. 5 and 13.

Referring to FIG. 14, a method of operating a worker (300, 400) in a vertical federated learning, vFL, system for training a split neural network, the vFL system including a master node, includes determining (1402) that gradients for neurons in a cut-layer of the split neural network were not received from the master node; in response to determining that the gradients were not received from the master node, generating (1404) imputed values of the gradients; performing (1406) backpropagation training of the split neural network using the imputed gradient values; calculating (1408) new layer outputs based on the backpropagation training; and transmitting (1312) the new layer outputs to the master node.

Generating the imputed values of the gradients may include generating synthetic values of the gradients using a generative model based on previously received values of the gradients.

The generative model may include a multivariate timeseries model.

The method may further include smoothing the imputed values of the gradients using an exponential smoothing algorithm based on previously received gradients. The smoothing may be performed according to the operation:

At′←At+(1−w)At−1
where At′ is the gradient to be used at sample interval t, Aₜ is the imputed gradient at sample interval t, At−1 is the gradient previously used at sample interval t−1, and w is a smoothing weight.

The method may further include determining that new gradients are being received from the master node; and smoothing the new gradients based on a previously used imputed gradients. The smoothing may be performed according to the operation:

At′←wAt−1+(1−w)Rt
where At′ is the gradient to be used at sample interval t, Rt is the actual gradient at sample interval t, At−1 is the gradient previously used at sample interval t−1, and w is a smoothing weight.

The worker may be a node in a wireless communication network.

Referring to FIGS. 11, 12 and 14, a worker (300, 400) of a vertical federated learning system (100), includes processing circuitry (303, 403); and memory (305, 405) coupled with the processing circuitry, wherein the memory includes instructions that when executed by the processing circuitry causes the network node to perform operations described above with respect to FIG. 14.

Referring to FIGS. 11, 12 and 14, a worker (300, 400) of a vertical federated learning system (100) adapted to perform the operations described above with respect to FIG. 14.

Referring to FIGS. 11, 12 and 14, a computer program comprising program code to be executed by processing circuitry (303, 403) of a worker (300, 400) of a vertical federated learning system (100), whereby execution of the program code causes the worker (300, 400) to perform the operations described above with respect to FIG. 14.

Referring to FIGS. 11, 12 and 14, a computer program product comprising a non-transitory storage medium including program code to be executed by processing circuitry (303, 403) of a worker (300, 400) of a vertical federated learning system (100), whereby execution of the program code causes the worker (300, 400) to perform the operations described above with respect to FIG. 14.

Explanations are provided below for various abbreviations/acronyms used in the present disclosure.

| Abbreviation | Explanation |
|---|---|
| 5GC | 5G Core Network |
| AUC | Area Under Curve |
| CN | Core Network |
| CQI | Channel Quality Indicator |
| E2E | End to End |
| EPC | Evolved Packet Core |
| EUTRAN | Evolved Universal Terrestrial Radio |
| | Access Network |
| gNB | RAN |
| hFL | Horizontal Federated Learning |
| KPI | Key Performance Indicator |
| ML | Machine Learning |
| MOS | Mean Opinion Score |
| NN | Neural Network |
| OSS | Operating and Support System |
| PDU | Power Distribution Unit |
| PGW | Packet Gateway |
| PSU | Power Supply Unit |
| QoE | Quality of Experience |
| QoS | Quality of Service |
| RAN | Radio Access Network |
| RSRP | Reference Signal Received Power |
| RSRQ | Reference Signal Received Quality |
| RSSI | Received Signal Strength Indicator |
| SGW | Serving Gateway |
| SLA | Service Level Agreement |
| SNR | Signal to Noise Ratio |
| UE | User Equipment |
| vFL | Vertical Federated Learning |

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of operating a master node in a vertical federated learning, vFL, system for training a split neural network, the vFL system including a plurality of workers, the method comprising:
receiving layer outputs for a sample period from one or more of the workers for a cut-layer at which the neural network is split between the workers and the master node;
determining whether layer outputs for the cut-layer were not received from one of the workers;
in response to determining that layer outputs for the cut-layer were not received from one of the workers, generating imputed values of the layer outputs that were not received;
calculating gradients for neurons in the cut-layer based on the received layer outputs and the imputed layer outputs;
splitting the gradients into groups associated with respective ones of the workers; and
transmitting the groups of gradients to respective ones of the workers.

2. The method of claim 1, further comprising:
determining whether layer outputs for the cut-layer were not received from the one of the workers from which layer outputs were not received for more than a threshold number of sample intervals; and
in response to determining that layer outputs for the cut-layer were not received from the one of the workers from which layer outputs were not received for more than the threshold number of sample intervals, re-shaping the cut-layer of the split neural network to exclude neurons associated with the one of the workers from which layer outputs were not received.

3. The method of claim 2, further comprising:
determining a new training batch size, cut layer, and/or neuron count for the split neural network based on the re-shaped cut-layer.

4. The method of claim 1, further comprising:
determining whether an accuracy of the split neural network is increasing or decreasing after a training round; and
in response to determining that the accuracy of the neural network is increasing, reducing a network footprint of the split neural network.

5. The method of claim 4, wherein reducing the network footprint of the neural network comprises performing at least one of: reducing a training batch size the neural network, reducing a number of neurons in a cut-layer of the split neural network, and increasing a drop-out rate for neurons in the cut-layer of the split neural network.

6. The method of claim 5, further comprising informing the workers of the change to the network footprint.

7. The method of claim 4, further comprising:
in response to determining that the accuracy of the neural network is decreasing, performing at least one of: increasing a training batch size the neural network, increasing a number of neurons in a cut-layer of the split neural network, and reducing a drop-out rate for neurons in the cut-layer of the split neural network.

8. The method of claim 4, wherein determining whether the accuracy of the split neural network is increasing or decreasing comprises generating a moving average of an accuracy score associated with the split neural network.

9. The method of claim 8, wherein the accuracy score comprises an F1-score.

10. The method of claim 1, wherein imputing the imputing values of the layer outputs that were not received comprises generating synthetic values of the layer outputs that were not received using a generative model based on previously received values of the layer outputs that were not received.

11. The method of claim 10, wherein the generative model takes into account previously received values of layer outputs other than the layer outputs that were not received in addition to the layer outputs that were not received.

12. The method of claim 10, wherein the generative model comprises a multivariate timeseries model.

13. The method of claim 1, further comprising:
smoothing the imputed values of the layer outputs that were not received using an exponential smoothing algorithm based on a previously used layer output value.

14. The method of claim 13, wherein smoothing is performed according to the operation:
A_{t′}←wAₜ+(1−w)Aₜ₋₁
where A_{t′} is the layer output to be used at sample interval t, Aₜ is the imputed layer output at sample interval t, Aₜ₋₁ is the layer output previously used at sample interval t−1, and w is a smoothing weight with 0<w<1.

15. The method of claim 1, further comprising:
determining that new layer outputs are being received from the one of the workers from which layer outputs were previously not received; and
smoothing the new layer outputs based on a previously used imputed layer output.

16. The method of claim 15, wherein smoothing is performed according to the operation:
A_{t′}←wAₜ₋₁+(1−w)Rₜ
where A_{t′} is the layer output to be used at sample interval t, Rₜ is the actual layer output at sample interval t, Aₜ₋₁ is the layer output previously used at sample interval t−1, and w is a smoothing weight with 0<w<1.

17. The method of claim 1, wherein the worker nodes comprise nodes in a wireless communication network.

18. The method of claim 1, further comprising:
identifying a trusted neighbor node of the one of the workers; and
obtaining a version of the layer outputs that were not received from the one of the workers from the trusted neighbor node.

19. The method of claim 18, further comprising:
combining the version of the layer outputs that were obtained from the trusted neighbor node with a previously imputed set of layer outputs for the one of the workers.

20-21. (canceled)

22. A master node of a vertical federated learning, vFL, system, comprising:
processing circuitry; and
memory coupled with the processing circuitry, wherein the memory includes instructions that when executed by the processing circuitry causes the master node to perform operations comprising:
receiving layer outputs for a sample period from one or more workers in the vFL for a cut-layer at which a neural network is split between the workers and the master node;
determining whether layer outputs for the cut-layer were not received from one of the workers;
in response to determining that layer outputs for the cut-layer were not received from one of the workers, generating imputed values of the layer outputs that were not received;
calculating gradients for neurons in the cut-layer based on the received layer outputs and the imputed layer outputs;
splitting the gradients into groups associated with respective ones of the workers; and
transmitting the groups of gradients to respective ones of the workers.

23-48. (canceled)
